(19) United States
(12) Patent Application Publication
(10) Pub. No.: US 2021/0265655 A1
(43) Pub. Date: Aug. 26, 2021

(54) METHOD FOR PRODUCING SULFIDE SOLID ELECTROLYTE

(71) Applicant: TOYOTA JIDOSHA KABUSHIKI KAISHA, Toyota-shi (JP)

(72) Inventor: Keiichi MINAMI, Sunto-gun (JP)

(73) Assignee: TOYOTA JIDOSHA KABUSHIKI KAISHA, Toyota-shi (JP)

(21) Appl. No.: 17/176,407

(22) Filed: Feb. 16, 2021

(30) Foreign Application Priority Data
Feb. 21, 2020 (JP) 2020-028270

(51) Int. Cl. H01M 10/0562; C03C 3/32

(52) U.S. Cl. CPC H01M 10/0562; H01M 2300/0068; C03C 3/321

(57) ABSTRACT

The present disclosure provides a method for producing a sulfide solid electrolyte having good ionic conductivity and water resistance. The method for producing a sulfide solid electrolyte includes: an amorphizing step of obtaining a sulfide glass by amorphizing a first raw material composition including Li₂S, Li₂CO₃, P₂S₅, LiI and LiBr, and a heating step of heating the sulfide glass at a temperature equal to or higher than a crystallization temperature.

### CROSS REFERENCE TO RELATED APPLICATIONS

This nonprovisional application claims priority to Japanese Patent Application No. 2020-028270 filed on Feb. 21, 2020, with the Japan Patent Office, which is incorporated herein by reference in its entirety.

### TECHNICAL FIELD

The present disclosure relates to a method for producing a sulfide solid electrolyte.

### BACKGROUND

With the recent rapid spread of information-related devices and communication devices such as personal computers, video cameras and mobile phones, it is important to develop batteries that are used as a power source. The automotive industry is also developing high-power, high-capacity battery for electric and hybrid vehicles. Among the types of batteries, the all solid state battery has attracted attention in that solid electrolyte is used instead of an electrolytic solution containing an organic solvent as an electrolyte interposed between cathode and anode. Also known as solid electrolyte is sulfide solid electrolyte.

For example, Patent Literature 1 discloses a method for producing a sulfide solid electrolyte material, the method comprising an amorphization step of amorphizing a raw material composition containing at least Li₂S, P₂S₅, LiI and LiBr, to obtain a sulfide glass, and a heat treatment step of heating the sulfide glass at a temperature of 195° C. or higher.

### PRIOR ART DOCUMENTS

### Patent Document

[Patent Document 1] JP-A-2015-011898

### SUMMARY OF THE INVENTION

### Problem to be Solved by the Invention

Although the sulfide solid electrolyte described in Patent Literature 1 has good ionic conductivity, it is easily deteriorated by moisture, and there is room for improving water resistance (moisture resistance). In view of the above circumstances, it is an object of the present disclosure to provide a method for producing a sulfide solid electrolyte having good ionic conductivity and water resistance.

### Means for Solving the Problem

In order to solve the above-mentioned problems, the present disclosure provides a method for producing a sulfide solid electrolyte, the method comprising: an amorphization step of obtaining a sulfide glass by amorphizing a first raw material composition including Li₂S, Li₂CO₃, P₂S₅, LiI and LiBr, and a heating step of heating the sulfide glass at a temperature equal to or higher than a crystallization temperature.

According to the present disclosure, by using Li₂CO₃ as a raw material, it is possible to obtain a sulfide solid electrolyte having excellent ionic conductivity and water resistance.

In addition, the present disclosure provides a method for producing a sulfide solid electrolyte, the method comprising: an amorphization step of obtaining a sulfide glass by forming a sulfide glass precursor by amorphizing a second raw material composition including Li₂CO₃, P₂S₅, LiI and LiBr, adding Li₂S to the sulfide glass precursor and further amorphizing, and a heating step of heating the sulfide glass at a temperature equal to or higher than the crystallization temperature.

According to the present disclosure, by using Li₂CO₃ as a raw material, it is possible to obtain a sulfide solid electrolyte having excellent ionic conductivity and water resistance.

In the above disclosures, the second raw material compositions may include no Li₂S.

In the above disclosure, a ratio A that is a ratio of the Li₂CO₃ to a sum of the Li₂S and the Li₂CO₃ may be 60 mol % or less.

In the above disclosure, the ratio A may be 20 mol % or more.

In the above disclosure, a ratio B that is a ratio of a sum of the Li₂S and Li₂CO₃ to a sum of the Li₂S, the Li₂CO₃ and the P₂S₅ may be 70 mol % or more, 80 mol % or less.

In the above disclosures, the sulfide solid electrolyte may comprise a crystal phase having peaks at 2θ=21.0°±0.5°, 28.0°±0.5° in X-ray diffractometry using CuKα radiation.

### Effect of the Disclosure

In the present disclosure, it is possible to obtain an sulfide solid electrolyte having good ionic conductivity and water resistance.

### BRIEF DESCRIPTION OF THE DRAWINGS

FIG. 1 is a flow diagram illustrating a first aspect of the manufacturing method of sulfide solid electrolyte in the present disclosure.

FIG. 2 is a flow diagram illustrating a second aspect of the manufacturing method of sulfide solid electrolyte in the present disclosure.

FIG. 3 is a flow diagram showing a manufacturing method of sulfide solid electrolyte in Comparative example 4.

### FORM FOR IMPLEMENTING THE INVENTION

Hereinafter, a method for producing a sulfide solid electrolyte in the present disclosure will be described in detail. The manufacturing method of a sulfide solid electrolyte in this disclosure can be roughly classified into a first aspect and a second aspect.

### A. First Aspect

The method for producing a sulfide solid electrolyte according to the first aspect includes an amorphizing step of obtaining a sulfide glass by amorphizing a first raw material composition including Li₂S, Li₂CO₃, P₂S₅, LiI, and LiBr, and a heating step of heating the sulfide glass at a temperature equal to or higher than a crystallization temperature.

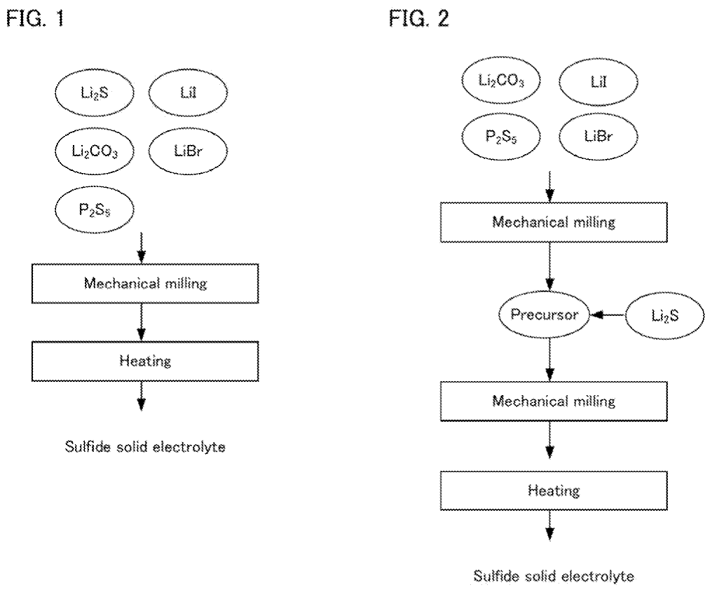

As shown in FIG. 1, in the sulfide solid electrolyte production process of the first embodiment, first, a first raw material composition containing Li₂S, Li₂CO₃, P₂S₅, LiI, and LiBr is prepared. Next, the first raw material composition is amorphized by mixing, for example, by mechanical milling to obtain sulfide glasses. Next, sulfide glasses are heated above the crystallization temperature to obtain sulfide solid electrolyte.

According to the first aspect, by using Li₂CO₃ as a raw material, a sulfide solid electrolyte having good ionic conductivity and water resistance can be obtained. As described above, although sulfide solid electrolyte described in Patent Literature 1 has good ionic conductivity, it tends to be deteriorated by moisture, and there is room for improving water resistance (moisture resistance). Therefore, the present inventors have conducted extensive studies, and found that by using Li₂CO₃ as a raw material, and more preferably, replacing a part of Li₂S to be used with Li₂CO₃, H₂S a sulfide solid electrolyte with a small amount of H₂S generation can be obtained while maintaining good ion conductivity. For example, replacing a portion of Li₂S to be used with an unresponsive material (e.g., Li₂O) can reduce the amount of H₂S generation, but reduces the amount of sulfide ions that are the backbone of ion transfer, resulting in a lower ion density. On the other hand, Li₂CO₃ can be used to achieve a sulfide solid electrolyte with low H₂S generation while maintaining good ion-conductivity. It is also possible to lower manufacturing costs by replacing some of Li₂S used with relatively inexpensive Li₂CO₃.

### 1. Amorphizing Step

The amorphizing step in the first embodiment is a step of obtaining a sulfide glass by amorphizing a first raw material composition including Li₂S, Li₂CO₃, P₂S₅, LiI and LiBr. Here, sulfide glass refers to a material synthesized by amorphizing a raw material composition, and means not only strict “glass” in which periodicity as crystals is not observed in X-ray diffractometry or the like, but also a whole material synthesized by amorphizing the raw material composition by mechanical milling or the like. Therefore, even when peaks originating from raw materials such as LiI are observed in X-ray diffractometry or the like, a material synthesized by amorphization corresponds to sulfide glasses.

The first raw material compositions contain Li₂S, Li₂CO₃, P₂S, LiI, and LiBr. The ratio (A) of Li₂CO₃ to the sum of Li₂S and Li₂CO₃ is, for example, 5 mol % or more, may be 10 mol % or more, may be 20 mol % or more. If the ratio A is too small, good water resistance may not be obtained. On the other hand, the ratio A is, for example, 70 mol % or less, and may be 60 mol % or less. If the ratio A is too small, good ionic conductivity may not be obtained.

In addition, the ratio of the sum of Li₂S and Li₂CO₃ (ratio B) to the sum of Li₂S, Li₂CO₃ and P₂S₅ is not particularly limited. The ratio B is, for example, 70 mol % or more, and may be 72 mol % or more, and may be 74 mol % or more. On the other hand, the ratio B is, for example, 80 mol % or less, and may be 78 mol % or less, and may be 76 mol % or less. In addition, when Li₂S:P₂S₅=75:25, a Li₃PS₄ can be stoichiometrically obtained. PS₄³⁻ corresponds to so-called ortho-compositional anionics and is chemically stable. Therefore, it is possible to reduce the amount of H₂S generation. If the ratio B is around 75 mol %, the percentage of PS₄³⁻ is relatively high and H₂S generation can be reduced.

Further, the ratio of Li₂CO₃ to the entire raw material W is not particularly limited. The above ratio is, for example, 10 mol % or more, and may be 15 mol % or more, and may be 20 mol % or more. On the other hand, the above ratio is, for example, 40 mol % or less, and may be 35 mol % or less, and may be 30 mol % or less. Incidentally, the entire raw material W refers to the sum of Li₂S, Li₂CO₃, P₂S₅, LiI and LiBr used in the amorphizing step.

In addition, the ratio of LiI to the entire raw material W is not particularly limited. The above ratio is, for example, 5 mol % or more, and may be 10 mol % or more. On the other hand, the above ratio is, for example, 20 mol % or less, and may be 15 mol % or less. Further, the ratio of LiBr to the entire raw material W is not particularly limited. The above ratio is, for example, 5 mol % or more, and may be 10 mol % or more. On the other hand, the above ratio is, for example, 20 mol % or less, and may be 15 mol % or less.

In addition, the ratio of the sum of LiI and LiBr to the entire raw material W is not particularly limited. The above ratio is, for example, 10 mol % or more, and may be 15 mol % or more, and may be 20 mol % or more. On the other hand, the above ratio is, for example, 30 mol % or less, and may be 25 mol % or less.

Further, the ratio of LiBr to the sum of LiI and LiBr is, for example, 5 mol % or more, and may be 10 mol % or more. On the other hand, the above ratio is, for example, 75 mol % or less, and may be 50 mol % or less.

Examples of a method of amorphizing the first raw material composition include a mechanical milling and a melt quenching method. The mechanical milling may be dry mechanical milling or wet mechanical milling, the latter being preferred. This is because more amorphous sulfide glasses can be obtained. Mechanical milling is not particularly limited as long as the method of mixing the raw material composition while imparting mechanical energy, such as ball mills, vibration mills, turbo mills, mechanofusion, disc mills.

In addition, various conditions of mechanical milling are set so that desired sulfide glasses can be obtained. The pedestal rotation speed at the time of performing the planetary ball mill is, for example, 200 rpm or more and 500 rpm or less, and may be 250 rpm or more and 400 rpm or less. Further, the processing time at the time of performing the planetary ball mill is, for example, 1 hours or more and 100 hours or less, and may be 1 hours or more and 50 hours or less.

As the liquid used for wet mechanical milling, it is preferable that the liquid has a property of not generating hydrogen sulfide by reaction with the raw material composition. Hydrogen sulfide is generated by reacting protons dissociated from molecules of a liquid with a raw material composition or a sulfide glass. Therefore, it is preferable that the above liquid has an aprotic property to such an extent that hydrogen sulfide does not occur.

### 2. Heating Step

The heating step in the first aspect is a step of heating the sulfide glass at a temperature equal to or higher than a crystallization temperature.

Crystallization temperatures T_{c} of sulfide solid electrolyte is, for example, 120° C. or more and 200° C. or less. Crystallization temperatures (T_{c}) of sulfide solid electrolyte can be determined by differential thermal spectrometry (DTA). Heating temperature in the heating step is T_{c} or more, may be (T_{c}+10° C.) or more, may be (T_{c}+20° C.) or more. On the other hand, the heating temperature is, for example, (T_{c}+50° C.) or less, may be (T_{c}+40° C.) or less, it may be (T_{c}+30° C.) or less. If the heating temperature is too high, the ionic conductivity of the resulting sulfide solid electrolyte may decrease. Specific heating temperatures include, for example, 170° C. to 240° C.

The heating time is not particularly limited as long as the desired sulfide solid electrolyte is obtained. The heating time is, for example, 1 minutes or more and 24 hours or less, and may be 1 minutes or more and 10 hours or less. Further, the heating is preferably performed in an inactive gas environment (e.g. Ar gas) or a decompression environment (e.g. in a vacuum). This is because degradation (e.g., oxidization) of sulfide solid electrolyte can be prevented. The method of heating is not particularly limited, and for example, a method using a firing furnace can be cited.

### 3. Sulfide Solid Electrolyte

In the first aspect, sulfide solid electrolyte usually contains Li, P, I, Br, and S. The type of the element constituting sulfide solid electrolyte can be confirmed, for example, by an ICP-emission analyzer. In addition, in the first aspect, sulfide solid electrolyte is usually a glass-ceramic. Glass-ceramics refers to a material obtained by crystallizing sulfide glasses. Whether or not the glass ceramics is used can be confirmed by, for example, an X-ray diffraction method.

It is preferable that sulfide solid electrolyte has a highly ionic conductive crystal phase. Among these, it is preferable that sulfide solid electrolyte has a crystal phase (crystal phase A) having peaks at 2θ=20.2°±0.5° and 23.6°±0.5° in X-ray diffractometry using CuKα rays. Crystal phase A is highly ionically conductive. In addition to 2θ=20.2°, 23.6°, crystal phase A usually peaks at 2θ=29.4°, 37.8°, 41.1°, 47.0°. These peak positions may also be back and forth within the range of ±0.5°. Sulfide solid electrolyte may be provided with crystal phase A as a main phase and may be a single phase material of crystal phase A.

Sulfide solid electrolyte may or may not comprise crystal phase (crystal phase B) having peaks at 2θ=21.0°±0.5°, 28.0°±0.5° in X-ray diffractometry using CuKα radiation. Crystal phase B is usually less ionically conductive than crystal phase A. In addition to 2θ=21.0°, 28.0°, crystal phase B typically has peaks at 2θ=32.0°, 33.4°, 38.7°, 42.8°, 44.2°. These peak positions may also be back and forth within the range of ±0.5°.

When the peak intensity of 2θ=20.2°±0.5° in crystal phase A is I_{20.2} and the peak intensity of 2θ=21.0°±0.5° in crystal phase B is I_{21.0}, I_{21.0}/I_{20.2} is, for example, 0.4 or less, may be 0.2 or less, or 0.1 or less. On the other hand, I_{21.0}/I_{20.2} may be 0 or larger than 0.

The ionic conductivity of sulfide solid electrolyte (25° C.) is preferably high. The ionic conductivity (25° C.) of sulfide solid electrolyte is, for example, 1 mS/cm or more. Further, examples of the shape of sulfide solid electrolyte include particulate. The mean D₅₀ of sulfide solid electrolyte is, for example, 0.1 μm or more and 50 μm or less. The use of sulfide solid electrolyte is not particularly limited, but is preferably used, for example, in an all-solid-state lithium-ion battery.

### B. Second Aspect

The method for producing a sulfide solid electrolyte according to the second aspect includes an amorphizing step of obtaining a sulfide glass by forming a sulfide glass precursor by amorphizing a second raw material composition including Li₂CO₃, P₂S₅, LiI, and LiBr, adding Li₂S to the sulfide glass precursor and further amorphizing, and a heating step of heating the sulfide glass at a temperature equal to or higher than a crystallization temperature.

As shown in FIG. 2, in a sulfide solid electrolyte production method according to the second embodiment, first, a second raw material composition including Li₂CO₃, P₂S₅, Lil, and LiBr is prepared. Next, the second raw material composition is amorphized, for example, by mixing by mechanical milling, to obtain a sulfide glass precursor. Further, Li₂S is added to the obtained precursor and amorphized to obtain a sulfide glass. Next, the sulfide glass is heated above the crystallization temperature to obtain sulfide solid electrolyte.

According to the second aspect, by using Li₂CO₃ as a raw material, a sulfide solid electrolyte having good ionic conductivity and water resistance can be obtained. Further, according to the second aspect, by amorphizing the second raw material composition containing Li₂CO₃ to form sulfide glass precursors, and then adding Li₂S to the second raw material composition to amorphize the second raw material composition again, Li₂CO₃ can be preferentially reacted with other raw materials such as P₂S₅, and Li₂CO₃ can be uniformly dispersed. Consequently, sulfide solid electrolyte having good ionic conductivity can be obtained.

### 1. Amorphizing Step

The amorphizing step in the second embodiment is a step of obtaining a sulfide glass by forming a sulfide glass precursor by amorphizing a second raw material composition including Li₂CO₃, P₂S₅, LiI, and LiBr, adding Li₂S to the sulfide glass precursor and further amorphizing.

The second raw material composition contains Li₂CO₃, P₂S₅, Lil, and LiBr. The second raw material compositions may or may not contain Li₂S, the latter being preferable. This is because generation of by-products due to Li₂S can be suppressed and ion conductivity can be easily improved. On the other hand, in the former case, when the weight of Li₂S contained in the second raw material composition is X and the weight of Li₂S added to the glass precursor is Y, X/(X+Y) is, for example, 50% by weight or less, and may be 30% by weight or less, or 10% by weight or less.

Since the ratio of the raw material, the method of amorphization, and other matters are the same as those described in the first embodiment above, description thereof is omitted here. The amorphization method for forming sulfide glass precursor and the amorphization method after adding Li₂S to sulfide glass precursor may be the same or different. Similarly, the amorphization conditions for forming sulfide glass precursor and the amorphization conditions after adding Li₂S to sulfide glass precursor may be the same or different.

### 2. Heating Step and Sulfide Solid Electrolyte

The heating step and the sulfide solid electrolyte in the second embodiment are the same as those described in the first embodiment above, and therefore description thereof is omitted here.

Note that the present disclosure is not limited to the above embodiments. The above-mentioned embodiments are illustrative, and anyone having substantially the same configuration as the technical idea described in the claims in the present disclosure and exhibiting the same operation and effect is included in the technical scope in the present disclosure.

### EXAMPLES

### Example 1

Based on the process shown in FIG. 1, sulfide solid electrolyte was produced. Specifically, as raw materials, 0.4260 g of Li₂S (Furuuchi Chemical Corporation) and 0.8587 g of P₂S₅ (Sigma-Aldrich Co. LLC.), 0.2757 g of LiI (Kojundo Chemical Lab. Co., Ltd.) and 0.2684 g of LiBr (Kojundo Chemical Lab. Co., Ltd.) and 0.1713 g of Li₂CO₃ (Kojundo Chemical Lab. Co., Ltd.) were introduced into zirconia pot (45 ml) with 5-mm diameter zirconia ball and further, dehydrated heptane (Kanto Chemical Industry Co., Ltd.) 4 g was put into the pot and the lid was put thereon. The pot was set in a planetary ball mill (FRITCH P-7) and mechanically milled for 20 hours to obtain sulfide glasses.

The ratio A in the raw material composition (the ratio of Li₂CO₃ to the sum of Li₂S and Li₂CO₃) was 20 mol %. On the other hand, the ratio B in the raw material composition (the ratio of the sum of Li₂S and Li₂CO₃ to the sum of Li₂S, Li₂CO₃ and P₂S₅) was 75 mol %. In each of the following examples and comparative examples, the ratio A was changed and the ratio B was fixed.

The obtained sulfide glass 2 g was charged into a zirconia pot together with a zirconia ball having a diameter of 0.3 mm, and further, a dibutyl Ether (manufactured by Kishida Chemical Co., Ltd.) 2 g and a heptane 6 g were charged and covered. The particle size of sulfide glasses was adjusted by stirring the pots for 20 hours. The resulting sulfide glasses were calcined by heating them in an inert atmosphere at a temperature above the crystallization temperature (200 to 230° C.) for 3 hours to obtain a sulfide solid electrolyte.

### Example 2

Sulfide solid electrolyte was obtained in the same manner as in Example 1 except that 0.2539 g of Li₂S (Furuuchi Chemical Corporation)), 0.8189 g of P₂S₅ (Sigma-Aldrich Co. LLC.), 0.2630 g of LiI (Kojundo Chemical Lab. Co., Ltd.), 0.2559 g of LiBr (Kojundo Chemical Lab. Co., Ltd.), and 0.4083 g of Li₂CO₃ (Kojundo Chemical Lab. Co., Ltd.) were used as raw materials.

### Example 3

Sulfide solid electrolyte was obtained in the same manner as in Example 1, except that, as a raw material, Li₂S (Furuuchi Chemical Corporation) 0.2000 g, P₂S₅ (Sigma-Aldrich Co. LLC.) 0.8064 g, LiI (Kojundo Chemical Lab. Co., Ltd.) 0.2590 g, LiBr (Kojundo Chemical Lab. Co., Ltd.) 0.2520 g, and Li₂CO₃ (Kojundo Chemical Lab. Co., Ltd.) 0.4825 g were used.

### Comparative Example 1

Sulfide solid electrolyte was produced without the use of Li₂CO₃. Specifically, sulfide solid electrolyte was obtained in the same manner as in Example 1 except that Li₂S (Furuuchi Chemical Corporation) 0.5503 g, P₂S₅ (Sigma-Aldrich Co. LLC.) 0.8874 g, LiI (Kojundo Chemical Lab. Co., Ltd.) 0.2850 g, and LiBr (Kojundo Chemical Lab. Co., Ltd.) 0.2773 g were used as raw materials..

### Comparative Example 2

Sulfide solid electrolyte was prepared without Li₂S. Specifically, sulfide solid electrolyte was obtained in the same manner as in Example 1 except that 0.7602 g of P₂S₅ (Sigma-Aldrich Co. LLC.), 0.2441 g of LiI (Kojundo Chemical Lab. Co., Ltd.), 0.2376 g of LiBr (Kojundo Chemical Lab. Co., Ltd.), and 0.7581 g of Li₂CO₃ (Kojundo Chemical Lab. Co., Ltd.) were used as raw materials.

### Comparative Example 3

Instead of Li₂CO₃, a Li₂O was used to produce sulfide solid electrolyte. Specifically, sulfide solid electrolyte was obtained in the same manner as in Example 1, except that Li₂S (Furuuchi chemical) 0.2890 g, P₂S₅ (Sigma-Aldrich Co. LLC.) 0.9322 g, LiI (Kojundo Chemical Lab. Co., Ltd.) 0.2994 g, LiBr (Kojundo Chemical Lab. Co., Ltd.) 0.2914 g, and Li₂O (Kojundo Chemical Lab. Co., Ltd.) 0.1880 g were used as raw materials..

### Example 4

Based on the process shown in FIG. 2, sulfide solid electrolyte was produced. Specifically, as a raw material, Li₂CO₃ (Kojundo Chemical Lab. Co., Ltd.) 0.5104 g, P₂S₅ (Sigma-Aldrich Co. LLC.) 1.0236 g, LiI (Kojundo Chemical Lab. Co., Ltd.) 0.3287 g, and LiBr (Kojundo Chemical Lab. Co., Ltd.) 0.3199 g, together with zirconium balls, were put into zirconium pots, and then dehydrated heptanes were put into the pot and the lid was put thereon. The pots were set in a planetary ball mill (FRITCH P-7) and mechanically milled for 15 hours to obtain sulfide glass precursors. 1.7461 g of the obtained precursors and 0.2539 g of Li₂S (made by Furuuchi Chemical Corporation) were put into a zirconia pot together with a zirconia ball, and dehydrated heptane was put into the zirconia pot to cover the zirconia pot. The pot was set in a planetary ball mill (FRITCH P-7) and mechanically milled for 15 hours to obtain sulfide glasses. A sulfide solid electrolyte was obtained in the same manner as in Example 1, except that the obtained sulfide glass was used.

### Comparative Example 4

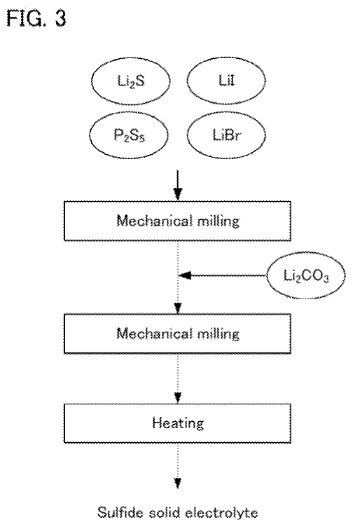

Based on the process shown in FIG. 3, sulfide solid electrolyte was produced. Specifically, 0.3174 g of Li₂S (Furuuchi Chemical Corporation), 1.0236 g of P₂S₅ (Sigma-Aldrich Co. LLC.), 0.3287 g of LiI, and 0.3199 g of LiBr (Kojundo Chemical Lab. Co., Ltd.) as raw materials, with zirconium balls were put into zirconium pot, and further dehydrated heptanes were put into the pot and the lid was put thereon. The pot was set in a planetary ball mill (FRITCH P-7) and mechanically milled for 15 hours to obtain sulfide glasses. 1.5197 g of the obtained sulfide glass and 0.4083 g of Li₂CO₃ (Kojundo Chemical Lab. Co., Ltd.) were put into a zirconia pot together with a zirconia ball, and dehydrated heptane was put into the zirconia pot to cover the pot. The pot was set in a planetary ball mill apparatus (FRITCH P-7) and mechanically milled for 15 hours. A sulfide solid electrolyte was obtained in the same manner as in Example 1, except that the obtained sulfide glass was used.

### [Evaluation]

### (Ionic Conductivity Measurement)

Ionic conductivity measure (25° C.) was performed on sulfide solid electrolyte obtained in Examples 1 to 4 and Comparative Examples 1 to 4. 100 mg of the obtained sulfide solid electrolyte powder was pressed at 6 ton/cm² pressure using a pellet molding machine to prepare a pellet. The resistance of the pellet was obtained by the AC impedance method, and the ionic conductivity was obtained from the thickness of the pellet. The results are shown in Table 1.

### (H₂S Generation Measurement)

A 1.5 L fan-sealed desiccator was prepared in a dry air glove box with a dew point of −30° C. After confirming that the dew point was stable, a petri dish containing 2 mg of the powder of sulfide solid electrolyte obtained in Examples 1 to 4 and Comparative Examples 1 to 4 was left in a desiccator for 30 minutes. The volume of H₂S generated was measured by aspirating 100 ml with a H₂S detection pipe (4LT made by GASTEC CORPORATION). The results are shown in Table 1.

TABLE 1

| | | | | Ionic | Volume |
|---|---|---|---|---|---|
| | | Amount of | Amor- | conduc- | of H₂S |
| | Carbonate | substitution | phizing | tivity | generated |
| | Oxide | (mol %) | step | (mS/cm) | (ppm) |
| Comparative | — | — | FIG. 1 | 4.0 | 4.0 |
| Example 1 | | | | | |
| Example 1 | Li₂CO₃ | 20 | | 2.0 | 1.4 |
| Example 2 | Li₂CO₃ | 50 | | 1.3 | 0.3 |
| Example 3 | Li₂CO₃ | 60 | | 1 | 0.2 |
| Comparative | Li₂CO₃ | 100 | | 0.1 | 0.1 |
| Example 2 | | | | | |
| Comparative | Li₂O | 50 | | 0.7 | 1.6 |
| Example 3 | | | | | |
| Example 4 | Li₂CO₃ | 50 | FIG. 2 | 2.5 | 0.1 |
| Comparative | Li₂CO₃ | 50 | FIG. 3 | 0.7 | 0.4 |
| Example 4 | | | | | |

Except for Comparative Example 3, the amount of substitution in Table 1 corresponds to the above-mentioned ratio A. On the other hand, the substitution amount in Comparative Example 3 means the ratio of Li₂O to the sum of Li₂S and Li₂O.

As shown in Table 1, in the sulfide solid electrolyte obtained in Examples 1 to 4, H₂S generation was suppressed while the ionic conductivity was maintained satisfactorily. In particular, in Example 4, the ionic conductivity was doubled as compared with Example 2. The reason for this is presumed to be that, in Example 4, Li₂CO₃ reacted preferentially with other raw materials such as P₂S₅, and Li₂CO₃ was evenly distributed. Further, in Example 4, as compared with Comparative Example 4, H₂S generation amount was ¼ times, the ion conductivity was 3 times or more. On the other hand, in Comparative Example 3, only about half of the ionic conductivity was obtained as compared with Example 2. Since S element and O element are the cognate element, a part of the S element is easily substituted for the O element. Since the polarizability of the element O is smaller than that of the element S, the ionic conductivity tends to be lowered. On the other hand, it was confirmed that a decrease in ionic conductivity can be suppressed by using carbonate ion (CO₃²⁻) instead of O element.

1. A method for producing a sulfide solid electrolyte, the method comprising:
an amorphizing step of obtaining a sulfide glass by amorphizing a first raw material composition including Li₂S, Li₂CO₃, P₂S₅, LiI and LiBr, and
a heating step of heating the sulfide glass at a temperature equal to or higher than a crystallization temperature.

2. A method for producing a sulfide solid electrolyte, the method comprising:
an amorphizing step of obtaining a sulfide glass by forming a sulfide glass precursor by amorphizing a second raw material composition including Li₂CO₃, P₂S₅, LiI and LiBr, adding Li₂S to the sulfide glass precursor, and further amorphizing, and
a heating step of heating the sulfide glass at a temperature equal to or higher than a crystallization temperature.

3. The method for producing a sulfide solid electrolyte according to claim 2, wherein the second raw material composition includes no Li₂S.

4. The method for producing a sulfide solid electrolyte according to claim 1, wherein a ratio A that is a ratio of the Li₂CO₃ to a sum of the Li₂S and the Li₂CO₃, is 60 mol % or less.

5. The method for producing a sulfide solid electrolyte according to claim 4, wherein the ratio A is 20 mol % or more.

6. The method for producing a sulfide solid electrolyte according to claim 1, wherein a ratio B that is a ratio of a sum of the Li₂S and the Li₂CO₃ to a sum of the Li₂S, the Li₂CO₃, and the P₂S₅ is 70 mol % or more and 80 mol % or less.

7. The method for producing a sulfide solid electrolyte according to claim 1, wherein the sulfide solid electrolyte comprises a crystal phase having peaks at 2θ=21.0°±0.5°, 28.0°±0.5° in X-ray diffractometry using CuKα radiation.
